(19) United States
(12) Patent Application Publication
(10) Pub. No.: US 2012/0318178 A1
(43) Pub. Date: Dec. 20, 2012

(54) FOLDING PLATFORM

(76) Inventors: Christopher Hanks, Jacksonville, FL (US); Gilbert Hanks, Jacksonville, FL (US)

(21) Appl. No.: 13/161,814

(22) Filed: Jun. 16, 2011

(51) Int. Cl. B60P 9/00

(52) U.S. Cl. 108/20; 108/44

(57) ABSTRACT

A folding platform assembly for the top deck of motor vehicle carrier trucks. The platform features a grate, whereupon a person may safely and comfortably walk along the length of the truck. The platform also features a safety net system affixed to the grate to catch a person in the event of a slip, trip, or fall from the grate. The grate has an access panel for easy ingress and egress to the platform from a ladder or set of steps. When storing or transporting the platform, a folding mechanism pushes the platform into its closed, substantially-vertical position. This same mechanism pulls the platform into its open position when it is ready for use.

### CROSS-REFERENCE TO RELATED APPLICATIONS

Not applicable.

### FEDERALLY SPONSORED RESEARCH

Not applicable.

### SEQUENCE LISTING OR PROGRAM

Not applicable.

### FIELD OF THE INVENTION

This invention generally relates to platforms. Specifically, this invention relates to folding platforms, particularly for use on motor vehicle carrier trucks.

### BACKGROUND OF THE INVENTION

Motor vehicle carrier trucks are designed to transport passenger vehicles, such as sedans, vans, pick-up trucks, and sport utility vehicles. These carrier trucks are typically capable of loading several vehicles into a bottom deck and a top deck. While the bottom deck may only be a few feet from the ground, the top deck is much higher, usually elevated eight or more feet above the ground. The decks upon which these vehicles are loaded, especially the top deck, are sometimes no more than two tire-wide runners, each spaced apart in such a fashion that the runners line up with the left-side and right-side tires of a standard passenger vehicle.

In the carrier truck industry, it is standard practice to load these vehicles onto the carrier truck deck by having a person enter the vehicle to be loaded, and physically drive the vehicle onto the decks by lining up the vehicle tires with the runners. A problem then arises once the vehicle has been loaded on the carrier truck: the person must then exit the vehicle, and negotiate a descent from the carrier truck. When the deck is made up only of the runners, the narrow and often slippery runners are the only footing, and any other part of the frame of the carrier truck is used for hand grips. This poses a substantial hazard to this person's safety, since the runners are not designed for foot travel, and the carrier truck frame is not designed to allow for secure gripping or to anchor safety equipment, such as a harness, to prevent someone from falling. As such, people negotiating the descent from the carrier truck are at risk of losing their footing or their grip. Slips or falls from the bottom and top decks of these carrier trucks can result in serious or fatal injuries.

The width of these carrier trucks and the decks they haul are restricted by the width of the highways and streets upon which they travel. These roadways are only wide enough to accommodate a standard passenger vehicle as it travels in its ordinary course along that road. For an ordinary passenger vehicle, these roads may offer ample room to comfortably drive within a lane of travel. However, there is significantly less room for the carrier truck, since the roadway must now accommodate not only the width of the passenger vehicle, but also the runners upon which they rest, and the frame of the carrier truck itself. Due to width restrictions of the roadways, it is imperative that any additions to the body of these carrier trucks, such as platforms, mirrors, and light's, add only minimally, if at all, to the overall width of the carrier truck. Furthermore, the width of a carrier truck is restricted by government agencies, such as a state's Department of Transportation.

The inefficiency and obvious safety deficiencies of commonly used procedures for dismounting a carrier truck after loading a vehicle necessitates a device designed to address these shortcomings.

Collapsing platforms are known in the prior art. Specifically, such platforms previously devised and utilized are known to consist basically of familiar, expected, or obvious structural configurations. By way of example, the prior art discloses a safety platform for sanding trucks in U.S. Pat. No. 4,613,155 to Greenwood, a pipeline construction safety platform in U.S. Pat. No. 6,830,127 to Johnson; and a vehicle step device in U.S. Pat. No. 6,880,843 to Greer, Jr.

A retracting platform has been disclosed in U.S. 2010-0230210 by Hanks. This platform substantially departed from the prior art in that it added little, if any width to the carrier truck in the platform's retracted state. Although this retracting platform offered many advantages over the prior art, it required many moving parts to retract and extend the platform. It is reasonably foreseeable that, with repeated use, these moving parts will show signs of wear and failure. The long-term maintenance of this retracting platform thus may be taxing to the user's time and resources.

In this respect, the folding platform for motor vehicle carrier trucks, according to the present invention, substantially departs from the conventional concepts and designs of the prior art. In so doing, the present invention provides an apparatus primarily developed for the purpose of providing a folding platform that minimizes the necessity of moving parts when transitioning from its closed state to its open state. Furthermore, the present invention adds little, if any width to the carrier truck in the platform's retracted state, yet in its extended state, such platform allows sufficient room for safe foot travel. The present invention also provides for a railing system integrated into such platform, and an access panel through the platform for dismounting the carrier truck.

Therefore, it can be appreciated that there exists a need for a new and improved folding platform, which can be used for vehicle carrier trucks. In this regard, the present invention substantially fulfills this need.

### SUMMARY OF THE INVENTION

Accordingly, the present invention is a folding platform for motor vehicle carrier trucks. Integrated into the platform is a grate, a safety net system, an access panel, and an anchor point to transfer the kinetic energy from a power source, like that provided by a hydraulics system, to retract and extend the platform. Personnel safety, efficiency, and cost-effectiveness are always goals in the motor vehicle carrier industry, and the present invention offers a unique tool to achieve those goals.

Although platforms have been provided for vehicles, even including collapsible platforms or platforms which have integrated a railing or safety net system, there is no known platform which can be simply and economically adapted for the above-mentioned carrier trucks without the addition of relatively complicated mechanisms.

In general, the platform is hingedly attached to the truck frame. The frame may be the two tire-wide runners upon which the cargo rests, a deck, or the body of the carrier truck itself. The platform extends along the length of the truck where an operator is most likely to be positioned when loading and unloading cargo. The exception to the length of the platform is at the access panel, where the operator will climb up a ladder, through the access panel, to access the upper deck of the truck.

The platform in its extended position is a substantially horizontal grate. This grate is to be constructed of a material lightweight enough so as to facilitate the transition to its substantially vertical, retracted position. Furthermore, the material must be sufficiently lightweight, as to minimize its overall contribution to the overall weight of the carrier truck, yet the grate must also be durable enough to bear the weight of at least one adult over many years of use.

As mentioned, the platform also features an access panel which, in its simplest form, is an aperture through which one may climb to access the upper deck of the truck. The panel in the preferred embodiment is located in the center of the grate, but can be located anywhere on the grate where a means to access the upper deck, such as a ladder, can be found. Optionally, the panel may feature a door or gate to prevent falls through the aperture.

The safety net system is fixed to the grate. In the preferred embodiment, safety net system is at an obtuse angle with respect to the grate, and it runs the entire length along the distal edge of the grate. The preferred embodiment also features a smaller net to prevent a person from falling backwards off the ladder.

The safety net system is supported along its perimeter by a safety frame. This frame must be strong enough to maintain the structural integrity of the entire safety net system in the event that a person was to fall into it. The safety frame can be supported at each end with a safety frame chain, attached to a safety frame pole that is anchored to the truck frame. The chain should be long enough to be substantially taut when the folding platform is fully open, yet slacken to allow the folding platform to fully close. Although the chain can be of the linking loop type, any cable, wire, or other appropriate equipment may be used. Similarly, the safety frame pole can be any rigid, lightweight material that will, when properly anchored to the truck frame, maintain the structural integrity of the folding platform and support the weight of a person using the platform.

The mesh in the safety net system can be a traditional rope-style net. However, any mesh that is durable, lightweight, and relatively weatherproof would be appropriate if it will prevent an adult from falling off the platform. This mesh is attached to the safety frame at a plurality of points with clips. The appropriate number of points to clip the mesh to the frame varies: the preferred embodiment will clip the corners of the mesh to the frame and feature clips every few feet in between.

The invention also features anchor points for attaching a folding mechanism that will provide the power to raise and lower the folding platform. In the preferred embodiment, such a mechanism is a hydraulics system, wherein one end of the piston is attached to the truck frame and the other is attached to the anchor point on the underside of the grate. A hydraulics system is a system exploiting pressurized fluids that is well known in the prior art and used as part of the standard equipment in the industry.

When installing this folding mechanism, it is important to be mindful that this mechanism should be pivotally attached to both the truck frame and the anchor point to accommodate the full range of motion of the folding platform. Upon activation of the hydraulics system, the hydraulic piston pushes outward on the anchor point, which in turn pushes the entire platform up into its folded position. Similarly, the hydraulics system can pull back on the piston, which lowers the platform to its open position.

Thus, the general features of the invention have been broadly outlined, such that the detailed description thereof that follows may be better understood. There are, of course, additional features of the invention that will be described, which will form the subject matter of the claims. The claims should be regarded as providing the limits of the present invention. It is to be noted that the invention is not limited to the details of construction, or to the arrangements of the elements set forth in the following description or representations in the figures. The invention is capable of other embodiments and of being used in a variety of ways for a multitude of purposes. Also, it is to be understood that the phraseology and terminology employed herein are for the purpose of description, and should not be regarded as limiting.

It is thus an object of this present invention to provide a platform allowing for safe foot travel. It is another object of this invention to accommodate safety equipment to prevent falls. It is yet another object of this invention to allow access to a means, such as a ladder, to safely ascend and descend from the top deck of a carrier truck.

Due to various limitations on a carrier truck's width imposed by governing agencies or by industry standards, it is therefore another object of the present invention to provide a platform that is large enough to sufficiently accommodate a person exiting a vehicle loaded on the carrier truck. Concurrently, it is an object of the invention to provide for a platform that can retract, so that when it is not in use, the retracted platform has little, if any, effect on the width of the carrier truck.

It is another object of the present invention to provide a new and improved folding platform, which provides advantages over the prior art, while simultaneously overcoming the disadvantages of the prior art.

It is another object of the present invention to provide a new and improved folding platform, which may be easily and efficiently manufactured and marketed.

It is a further object of the present invention to provide a new and improved folding platform, which is durable and reliable in design and structure. At the same time, it is yet another object to provide an esthetically pleasing folding platform.

An additional object of the present invention is to provide a new and improved folding platform, which provides a simple, easy-to-operate apparatus.

Vet another object of the present invention is to provide a new and improved folding platform, wherein, considering the cost of materials and labor, manufacture of the invention provides an economic advantage. Such an advantage can be passed to the consumer, thus making the invention more accessible to the public.

Still another object of the present invention is to provide a safety measure for persons who are maneuvering about or dismounting the decks of a motor vehicle carrier truck.

These, together with other objects of the invention, along with the various features of novelty which characterize the invention, are pointed out with particularity in the claims, which are a part of this disclosure. For a better understanding of the invention, its operating advantages and the specific objects attained by its uses, reference should be made to the accompanying description and figures, in which there are illustrated preferred embodiments of the invention.

Further objects and advantages of this invention will become apparent from a consideration of the drawings and ensuing description.

While the above description contains many specificities, these should not be construed as limitations on the scope of the invention, but as exemplifications of the presently preferred embodiments thereof. Thus, the scope of the invention should be determined by the appended claims and their legal equivalents, and not by the examples given. Many other ramifications and variations are possible within the teachings of the invention. For example, the folding platform can be used on transportation means other than motor vehicle carrier trucks, such as trains or water craft, or on fixed structures like buildings, piers, or loading docks.

In view of the foregoing disadvantages inherent in the known types of platforms present in the prior art, the present invention provides an improved platform for motor vehicle carrier trucks. As such, the general purpose of the present invention, which will be described in greater detail, is to provide a new and improved folding platform, which has all the advantages of the prior art, and none of the disadvantages.

### DRAWINGS

### Figures

The features and advantages of the present invention will be better understood and objects other than those set forth will become apparent when consideration is given to the following detailed description thereof. Such description makes reference to the annexed drawings wherein:

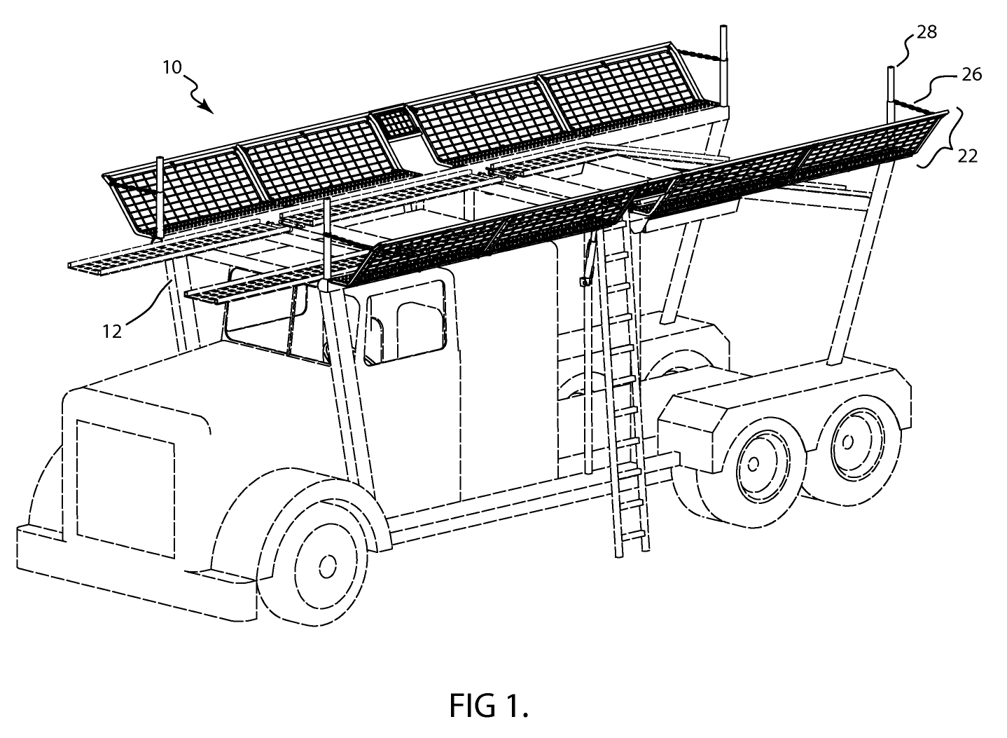

FIG. 1 is a perspective view of the folding platform in its open position;

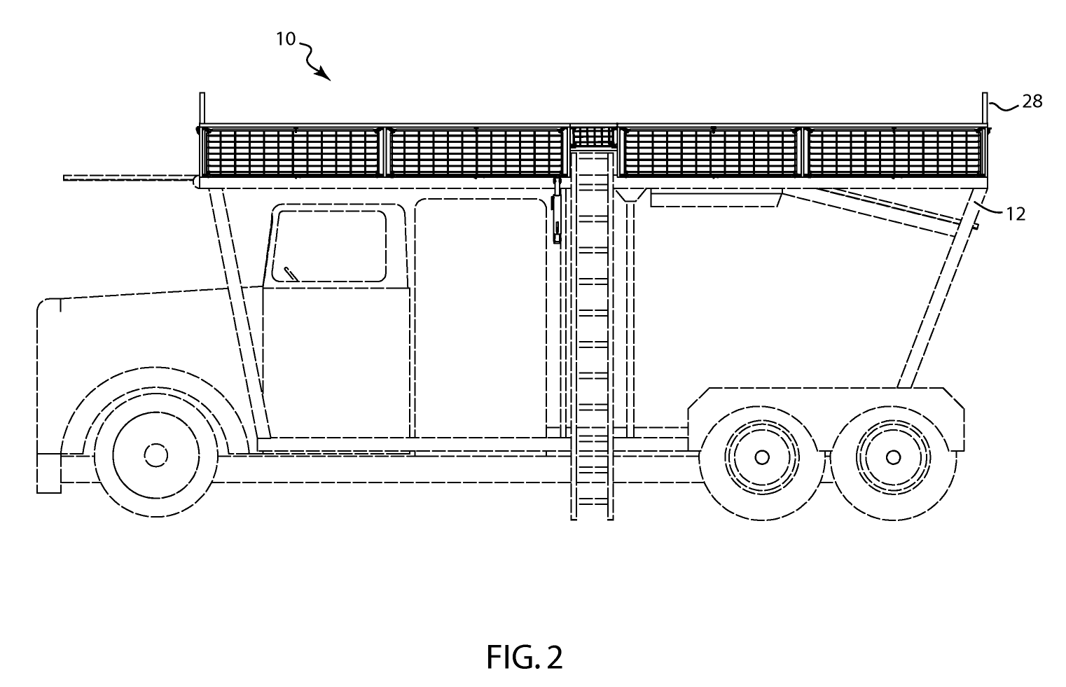

FIG. 2 is a side elevational view, the opposite side being a mirror image thereof;

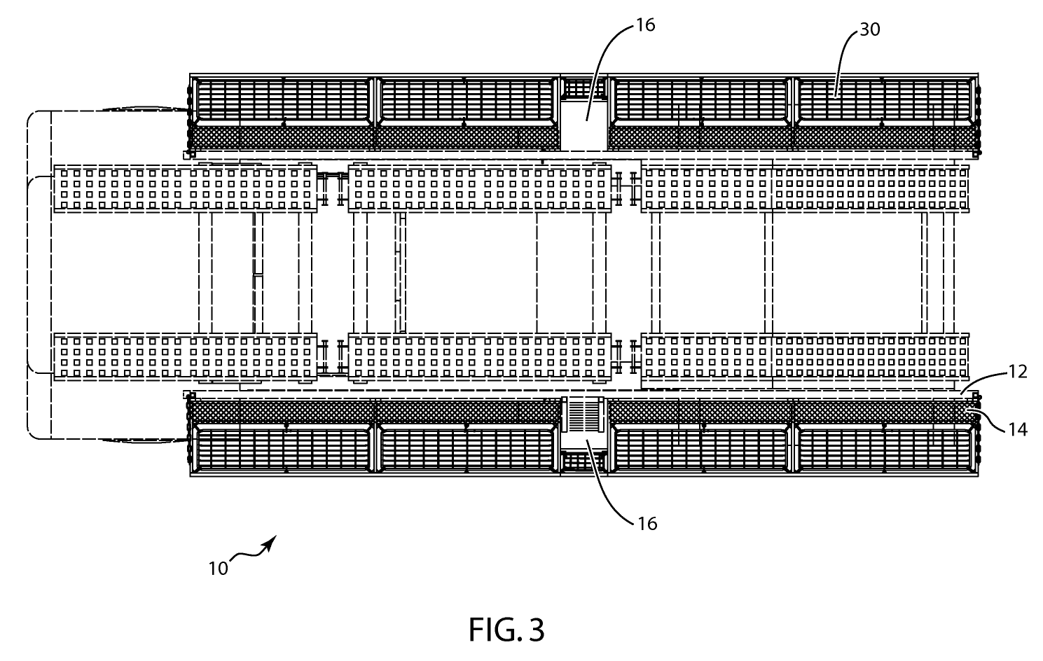

FIG. 3 is a top view thereof;

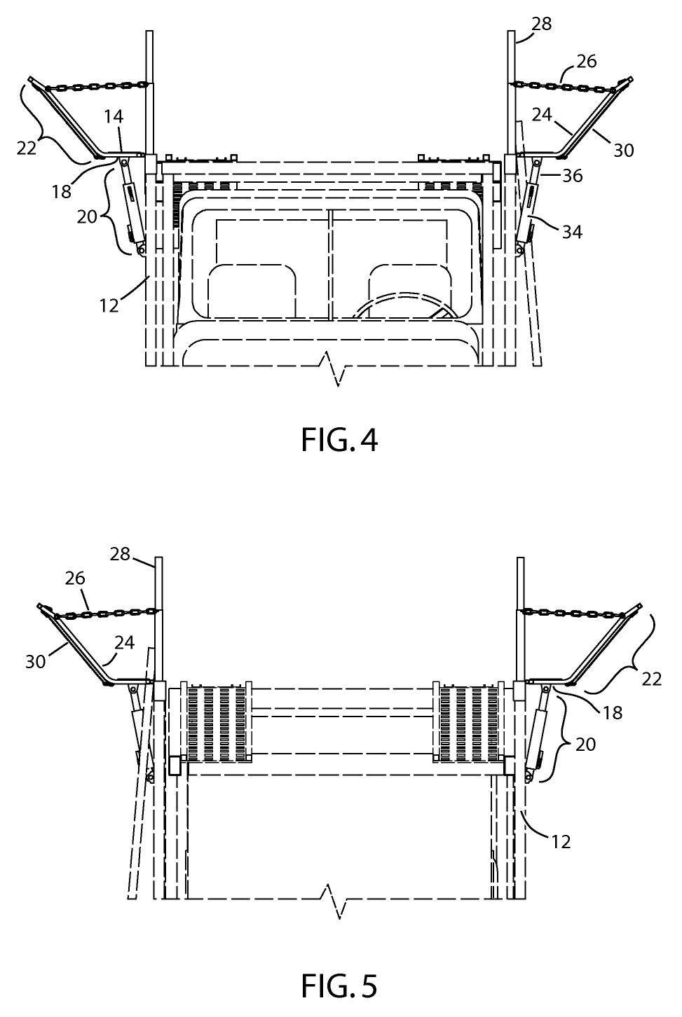

FIG. 4 is a front elevational view of the folding platform in the open position;

FIG. 5 is a rear elevational view of the folding platform in the open position;

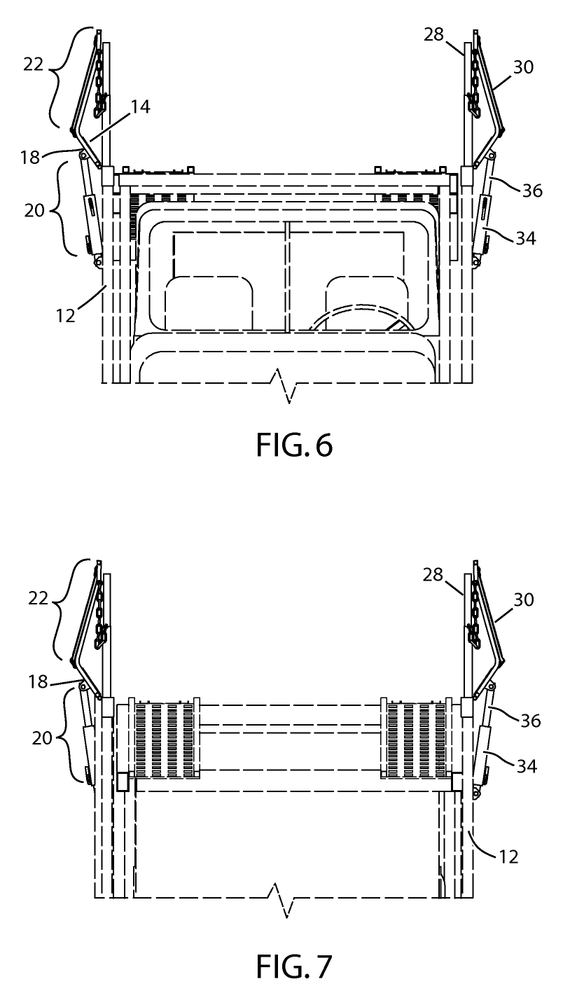

FIG. 6 is a front elevational view of the folding platform in the closed position;

FIG. 7 is a rear elevational view of the folding platform in the closed position;

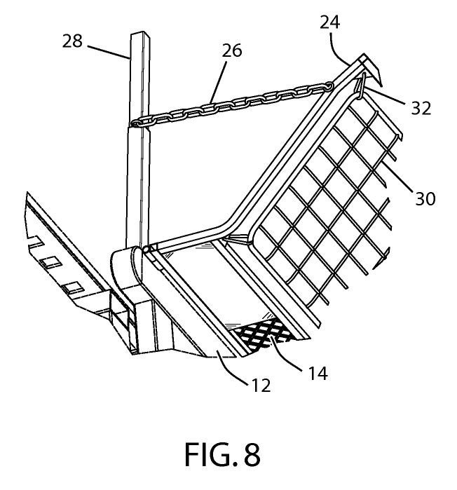

FIG. 8 is a perspective view of the safety net system;

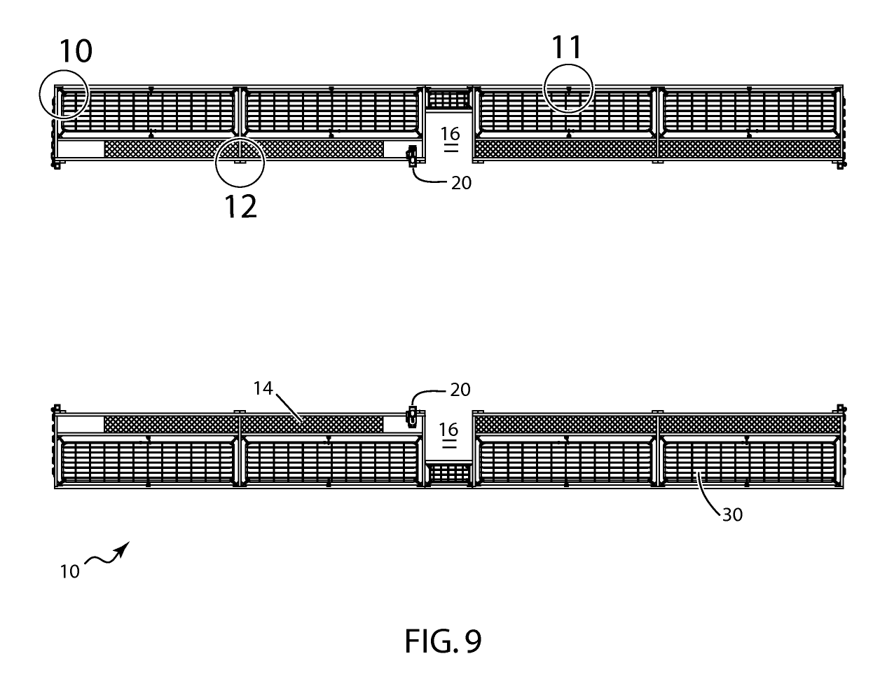

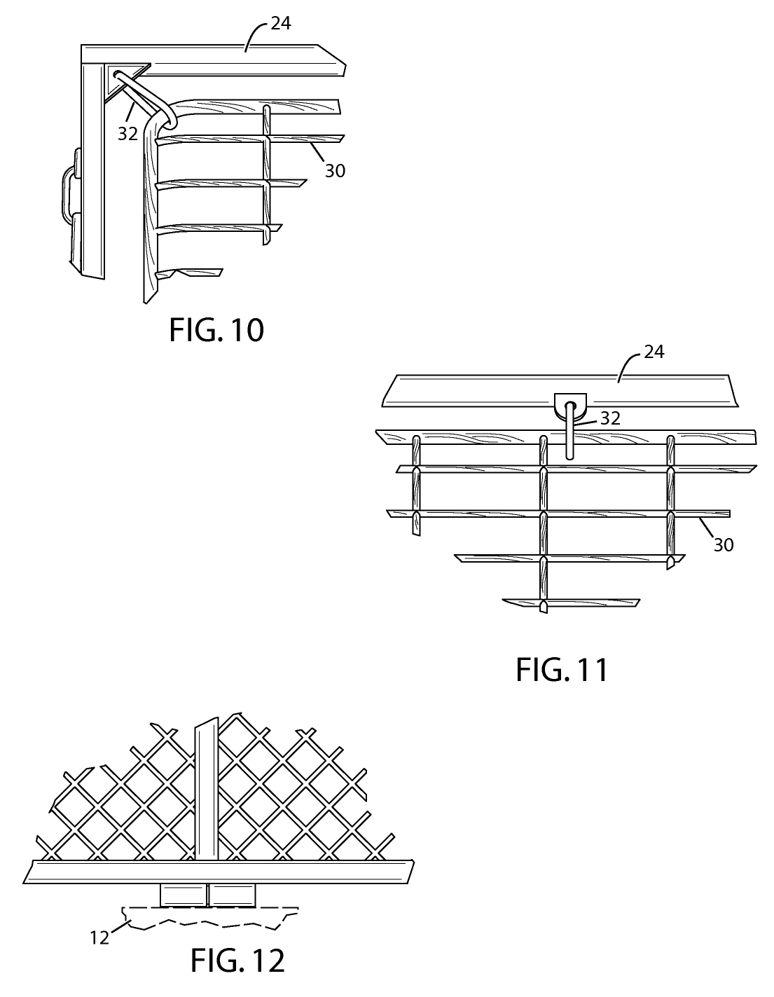

FIG. 9 is a bottom view of the folding platform, with points of reference for the enlarged views depicted in FIGS. 10-12;

FIG. 10 is an enlarged view of a clip attaching the mesh to a corner of the safety frame, as referenced in FIG. 9;

FIG. 11 is an enlarged view of a clip attaching the mesh along the length of the safety frame, as referenced in FIG. 9;

FIG. 12 is an enlarged view of the hinged joint securing the folding platform to the truck frame, as referenced in FIG. 9; and

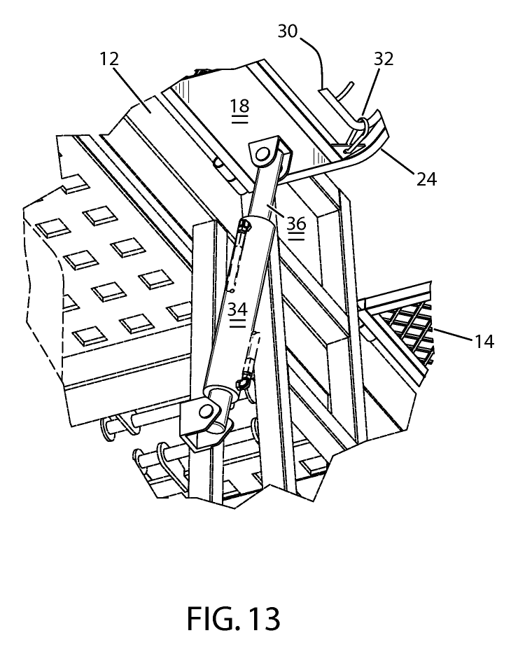

FIG. 13 is a perspective view of the folding mechanism, where it is secured to the anchor point and the truck frame.

### REFERENCE NUMERALS

10 Folding platform
12 Truck frame
14 Grate
16 Access panel
18 Anchor point
20 Folding mechanism
22 Safety net system
24 Safety frame
26 Safety frame chain
28 Safety frame pole
30 Mesh
32 Clip
34 Hydraulics system
36 Hydraulics piston

### DESCRIPTION OF THE INVENTION

With reference now to the drawings, and in particular, FIGS. 1-13, for a new and improved folding platform for motor vehicle carrier trucks, as generally designated by the reference numeral 10, the principles and concepts of the present invention will be described.

A motor vehicle carrier truck, typical of those used in the industry, has a frame 12, as illustrated in FIG. 1. A truck's frame 12 forms the supporting skeleton of the cargo-carrying portion of the carrier truck, and equipment such as lighting and hydraulics systems may be anchored or fixed on the frame 12. The frame 12 may also be the outer edge of the decks or runners, upon which the cargo rests.

The present invention, the new and improved folding platform, is comprised of a plurality of components. Such components, in their broadest context, include a grate 14, an access panel 16, an anchor point 18, and a folding mechanism 20. The components also include a safety net system 22, comprising a safety frame 22, a safety frame chain 26, a safety frame pole 28, mesh 30, and a plurality of clips 32. Such components are individually configured and correlated with respect to each other as to attain the desired objective.

FIGS. 1 through 5 show the platform 10 to be in its extended position, while FIGS. 6 and 7 show the platform 10 in its closed position.

In the open state, the platform grate 14 is substantially horizontal, and runs lengthwise along the truck frame 12. The grate 14 must be sufficiently wide enough and weight-bearing to support at least one adult, since it is expected that people would walk and stand on the grate 14. An access panel 16 is part of the grate 14. The panel 16 provides a means of ingress to and egress from the platform 10, and should be lined up with a means of safely accessing the platform 10, such as a ladder or steps. In alternative embodiments, the panel 16 may feature a hinged door to prevent a person from falling through the panel 16 when walking along the grate 14.

A safety net system 22 is affixed along the outer edge of the grate 14 to prevent a person from falling off the grate 14. This system 22 includes a safety frame 22 around the perimeter of the system, to maintain the system's integrity during use or storage. The safety frame 24 also features a safety frame chain 26 attaching the frame 24 to a safety frame pole 28. This arrangement is illustrated in FIG. 8. In the preferred embodiment, the pole 28 is anchored into the truck frame 12. The chain 26 and the pole 28 provide additional strength to the safety net system 22, in the event that someone was to fall into it.

The mesh 30 is preferably a series of nets attached to the safety frame 24 with a plurality of clips 32. The mesh 30 can be made of rope, metal chain, plastic, or other synthetic material, the purpose being to catch someone who was to fall off the grate 14. The purpose for the plurality of clips 32 in the preferred embodiment is to allow the mesh 30 to be replaced. Thus, although the clips 32, as seen in detail in FIGS. 10 and 11, are rugged, weather-resistant carabiner-style clips, they may optionally be permanent hooks, loops, or other similar fasteners for affixing the mesh 30 to the safety frame 24.

The anchor point 18 is where the folding mechanism 20 to fold and unfold the platform 10 is attached. The preferred embodiment features one anchor point 18 under each side of the platform 10, near its center of gravity. However, the folding platform 10 may optionally feature several anchor points along the length of the underside of the grate 14.

It is common in the motor carrier truck industry to equip the trucks with a standard hydraulics system 34, similar to that illustrated in FIG. 13. As such, the carrier truck's existing hydraulics system is the folding mechanism 20 that can be easily adapted to accommodate the folding platform 10 described herein, providing the power to open and close the platform 10. In the preferred embodiment, the hydraulics system is pivotally attached to the truck frame 12. Similarly, the hydraulics piston 36 is pivotally attached to the anchor point 18. When the folding mechanism 20 is engaged, the piston 36 can either push up on the underside of the platform 10 to fold it, or pull down on it to open the platform 10.

As to the manner and usage of the present invention, the same should be apparent from the above description.

With respect to the above description, it is to be realized that, to achieve the optimum relationships for the parts, consideration must be made to variations in size and dimension, materials, shape, form, function, and the manner of operation, assembly, and use. Such considerations are intended to be encompassed by the present invention, and will be readily apparent and obvious to one skilled in the art. All suitable modifications, adaptations, and equivalents may be resorted to, falling within the scope of the invention. Although one embodiment has been illustrated in the accompanying drawings and described in the foregoing detailed description, it will be understood that the intention is not limited to the embodiment discussed, but is capable of numerous rearrangements, modifications, and substitutions without departing from the spirit and scope of the invention. Other changes, and uses within the scope of the invention, as defined by the appended claims, will suggest themselves to those versed in the art. This application is intended to cover such departures from the present disclosure as those falling within known or customary practice in the art to which this invention pertains, and which falls within the limits of the appended claims.

It will be noted that this invention fully meets the objectives set forth.

The invention claimed is:

1. A folding platform for trucks, comprising:
a. a grate pivotally attached to the truck frame,
b. an access panel,
c. a safety net system, and
d. a folding mechanism.

2. The folding platform as recited in claim 1, wherein a door is hingedly attached to the grate to cover the access panel when said platform is in its open position.

3. The folding platform as recited in claim 1, wherein said safety net system is comprised of a safety frame, a safety frame chain, a safety frame pole, mesh, and a plurality of clips.

4. The folding platform as recited in claim 1, wherein said folding mechanism is a hydraulics system.
